(19) United States
(12) Patent Application Publication
(10) Pub. No.: US 2026/0319834 A1
(43) Pub. Date: Oct. 15, 2026

(54) SMART JOB MANAGEMENT PLATFORM

(71) Applicant: T-Mobile USA, Inc., Bellevue, WA (US)

(72) Inventors: Arin Banerjee, Kent, WA (US); Prasad Changole, Issaquah, WA (US); Chaitanya Laxminarayana, Austin, TX (US)

(21) Appl. No.: 19/178,733

(22) Filed: Apr. 14, 2025

(51) Int. Cl. G06F 9/48; G06F 9/50; G06F 11/07

(52) U.S. Cl. CPC G06F 9/4881; G06F 9/505; G06F 11/079

(57) ABSTRACT

The present disclosure describes approaches for managing the execution of jobs in a computing environment. Some implementations determine job demands for computing resources. Some implementations determine optimized scheduling times based on resource demands for one or more jobs. Some implementations detect potential resource issues prior to execution and, in some cases, determine actions to perform to mitigate such potential resource issues. Some implementations monitor execution of jobs and predict potential resource issues or detect resource issues that arise during execution. Some implementations determine and/or perform actions to remediate or mitigate issues that arise or may arise during execution of a job.

### BACKGROUND

Scheduling, queuing, and running jobs in computing environments is a common task, and doing so effectively can be important for managing computing resources and ensuring that jobs execute successfully. Batch processing typically involves executing multiple jobs without human intervention. Often, jobs are scheduled to run at specific times or in response to certain conditions. Scheduled or batch processing can be particularly useful for tasks that require significant computational power or need to be performed regularly, such as data processing, backups, and large-scale computations such as training machine learning models or running complex simulations. By automating these tasks, organizations can ensure that they are completed consistently and on time.

There are significant considerations when scheduling jobs, such as handling dependencies, prioritizing jobs, and managing resources efficiently. Monitoring tools can provide information about job status, resource usage, and potential issues. However, there are significant limitations to current approaches for scheduling and managing jobs. Accordingly, there is a need for improved approaches to managing batch jobs.

### BRIEF DESCRIPTION OF THE DRAWINGS

Detailed descriptions of implementations of the present invention will be described and explained through the use of the accompanying drawings.

FIG. 1 is a drawing that schematically illustrates an example computing environment that can be used for executing jobs according to some implementations.

FIG. 2 is a block diagram that illustrates an example smart management platform and associated external components according to some implementations.

FIG. 3 is a block diagram that illustrates an example of machine learning training and deployment according to some implementations.

FIG. 4 is a block diagram that illustrates an example job execution and monitoring process according to some implementations.

FIG. 5 is a flowchart that illustrates an example resource-aware scheduling process according to some implementations.

FIG. 6 is a flowchart that illustrates an example job execution time prediction and scheduling optimization process according to some implementations.

FIG. 7 is a block diagram that illustrates an example of a computer system in which at least some operations described herein can be implemented.

The technologies described herein will become more apparent to those skilled in the art from studying the Detailed Description in conjunction with the drawings. Embodiments or implementations describing aspects of the invention are illustrated by way of example, and the same references can indicate similar elements. While the drawings depict various implementations for the purpose of illustration, those skilled in the art will recognize that alternative implementations can be employed without departing from the principles of the present technologies. Accordingly, while specific implementations are shown in the drawings, the technology is amenable to various modifications.

### DETAILED DESCRIPTION

The description and associated drawings are illustrative examples and are not to be construed as limiting. This disclosure provides certain details for a thorough understanding and enabling description of these examples. One skilled in the relevant technology will understand, however, that the invention can be practiced without many of these details. Likewise, one skilled in the relevant technology will understand that the invention can include well-known structures or features that are not shown or described in detail, to avoid unnecessarily obscuring the descriptions of examples.

Scheduling jobs to run on computing systems is common for businesses and other organizations (generally referred to as organizations herein), which often have a significant number of reports, dashboards, and so forth that need to be updated, or scheduled jobs may need to be executed as part of certain business processes, in order to make up-to-date data available to certain applications, and so forth. Scheduling jobs is also common in other contexts, such as researchers who run complex calculations, reports, etc., or developers who may need to run long, computationally intensive compilations, machine learning model trainings, and so forth.

Scheduled jobs, batch jobs, and so forth (generally “jobs”) often involve large amounts of data, a large volume of computations, or both, and can take a significant amount of time to run, while some other scheduled jobs may be relatively small. For example, running a company-wide reporting job may take a long time and involve very large amounts of data, while running a similar reporting job that only looks at a specific store can be much faster and involve much less data. If the company-wide reporting job is executed before the store-specific reporting job, the store-specific reporting job may be significantly delayed while waiting for the company-wide reporting job to finish.

In some cases, jobs may be explicitly scheduled. That is, a job can be assigned a specific execution time or given a time range in which the job can begin executing. In some cases, jobs may not be explicitly scheduled. For example, jobs can be added to a queue, and jobs within the queue can be executed as computing resources become available to accept new jobs. It will be appreciated that some modern computing systems can run multiple jobs simultaneously. However, there can be significant performance impacts when too many jobs are run on the same computing system simultaneously. The number of jobs that can be run effectively on the same computing system simultaneously can depend on various factors, such as the number of processor cores the computing system is equipped with, the ability of jobs running on the computing system to take advantage of multiple cores, and so forth. When multiple jobs are running at the same time on a computing system, the jobs may compete for resources. As a result, jobs may take longer to execute or may fail entirely, for example due to timeouts, out of memory errors, and so forth.

Maintaining servers and other IT infrastructure is challenging and has significant costs. Moreover, organizations have traditionally had to carefully plan their IT infrastructure so that sufficient resources are available to allow operations to continue smoothly, while avoiding investing in too many resources such that systems are often idle and not being put to productive use. Organizations have increasingly moved to cloud-based services for much of their operations, which can alleviate many of the problems associated with organizations maintaining their own servers. Cloud environments can have many benefits, such as scalability and on-demand resources.

As described herein, there are many challenges associated with running scheduled jobs or batch jobs. For example, jobs may fail if a system runs out of memory, jobs may be delayed because other resource-intensive jobs are running, and so forth. In the case of cloud services, a cloud service provider may utilize a credit-based system or similar system to facilitate payment for computing services. If a company runs out of credits while a job is running, the job may stop. This can have significant implications. For example, if a process does not use atomicity, consistency, isolation, durability (ACID) transactions, a database table may be left in a partially updated state, creating significant data integrity concerns. As another example, a money transfer may involve multiple changes (e.g., debiting one account and crediting another); if ACID transactions aren't used and the updates fail partway, money may be debited from one account without being credited to the other, or money may be credited to one account without being debited from the other. ACID transactions help ensure that a single logical operation either fully completes or fails entirely, thereby helping to preserve data integrity. However, even if ACID transactions are used, restarting a job and resuming where it left off can be challenging and may not be possible if intermediate results are not available. Even if it is possible to recover a job, doing so can involve significant time on the part of engineers, system administrators, developers, and so forth. For example, consider a series of funds transfer transactions. If a job fails partway through, some transactions may have been completed while others have not. If the job is resumed in the wrong place, some transactions may be skipped entirely or repeated (e.g., if a transaction was already completed and is then performed again, there can be two funds transfers even though only one was intended). Failures can result in significantly delayed completion of jobs, increased costs (e.g., for personnel to resolve issues or computing costs associated with rerunning code, verifying data, etc.), and so forth.

Accordingly, there is a need for improved approaches to managing jobs. The approaches described herein can be used to manage jobs, optimize scheduling, predict completion times, optimize prioritization, and so forth. In some implementations, the approaches herein utilize self-healing mechanisms to automatically manage the execution of various jobs. For example, self-healing mechanisms can include automatically restarting jobs, automatically terminating jobs, automatically rescheduling jobs, automatically moving jobs to different systems, automatically restarting virtual machines, automatically restarting clusters, automatically managing credits for a cloud platform, and so forth.

There are many existing tools for managing jobs. However, these tools are typically very limited in their functionality. While they can provide information about jobs, such as whether a job is queued, executing, finished, or in an error state, they provide little or nothing to maintain smooth functioning and job executions. For example, existing tools generally are not proactive about issues that arise before or during job execution, such as scheduling optimization, preventing errors, and addressing errors, performance problems, or other issues that do arise during prosecution.

The approaches described herein can provide an improved job management platform. The platform as described herein can recommend optimal scheduling times, for example by predicting periods of reduced network congestion or computational workloads. In some implementations, the platform described herein analyzes past performance data to recommend optimized times to execute large queries, data transfers, computations, etc. The platform can improve performance in various ways, for example by allocating jobs to particular machines (for example, allocating jobs to reduce the amount of data that needs to be transferred between different data centers), terminating queries that are taking too long to execute (which may indicate a problem with the query itself, with a network connection, with a server, etc.) and so forth. In some implementations, the platform proactively resolves issues that arise or may arise during execution. The platform can predict issues and take measures to resolve problems before they occur, such as reallocating available resources, rescheduling jobs, pausing jobs, increasing a number of available credits, and so forth.

As described herein, it can be beneficial to analyze jobs and make certain predictions about them. For example, the resources needed to run different jobs can vary widely based on the calculations or other manipulations to be carried out, the amount of data to be manipulated or transferred, and so forth. For example, the number of rows in a database table that need to be read, updated, etc., can significantly impact how long it takes for a job to execute, how much memory will be needed, and so forth. Similarly, file sizes can have a significant impact on processing times, resource demands, and so forth. For example, processing large images would generally be expected to be more resource-intensive and time-consuming than similar processing of small images.

In some implementations, the approaches herein analyze job metadata to determine resource demand levels for one or more jobs. For example, a system can be configured to extract metadata to determine job parameters such as the number of rows in a file or database table, the size of a file to be read, written, etc., the number of files or database tables affected, and so forth. Some job parameters may be included in the metadata itself, while other job parameters may be derived from the metadata. For example, job metadata can indicate which tables are affected, and the system can analyze those tables to determine rows, columns, etc., for example by executing one or more database queries. As another example, job metadata may specify a file to be used during execution of the job, and the system can execute a filesystem operation to determine to size of the file. This information can help the system determine demand levels for various resources, indicating which and/or how many resources will be needed to execute the job, such as how much RAM will be used, how much non-volatile storage will be used, how much data will be transferred over a network connection, and so forth. In some implementations, the system can determine whether certain hardware is needed. For example, certain machine learning tasks may only operate on computing systems with suitable hardware accelerators (e.g., graphics processing units (GPUs), neural processing units (NPUs), field programmable gate arrays (FPGAs), etc.). In some implementations, the system can determine if particular software is needed for running a job. For example, some jobs may have one or more software dependencies require that certain libraries, applications, etc., be available (e.g., a job could utilize a Python script that will only run if matplotlib is available on the computing system). Determining hardware and/or software requirements can enable a platform as described herein to identify a subset of available computing resources that are suitable for running particular jobs.

In some implementations, a system analyzes historical jobs to estimate the needs of upcoming jobs or jobs that are currently executing. For example, the same job may be run daily, weekly, monthly, etc., and past runs of the job can be used when estimating how long a subsequent run will take. However, it will be appreciated that simply using prior run times may lead to inaccurate estimates. For example, there may be significant changes in the volume of data to be processed, available resources may differ significantly from what was available during past runs due to equipment upgrades, downgrades, failures, etc., differences in what other jobs or demands are being placed on relevant systems (e.g., database servers), and so forth. As described herein, a machine learning model can be used to predict execution times, optimize scheduling, or both, among other uses.

It can be significant to understand the total computing resources for executing jobs (e.g., total computing resources without consideration of what jobs are running or scheduled to run), the total resources available for executing jobs (e.g., which of the total computing resources are actually available currently or expected to be available for running jobs), or both. For example, a computing resource may currently be available for running a job or may be currently occupied but expected to be available at a later time when a particular job is run. These can be different as some computing resources may be otherwise occupied and not available for executing jobs that have not yet started being run, for example because they are being used for other jobs or otherwise are unavailable, for example due to system crashes, updates, backups, scheduled maintenance, etc. For example, there may be a certain number of computing resources (e.g., physical machines, virtual machines, or both) available for executing jobs. These computing resources can have certain amounts of computing resource components, such as central processing unit (CPU) cores, hardware accelerators, hardware accelerator cores, hardware accelerator types (e.g., GPU, NPU, FPGA), random access memory (RAM), non-volatile storage (e.g., solid state storage, magnetic disk storage), network interface capacity (e.g., one or more wired and/or wireless network cards, which may be capable of different transfer speeds), and so forth. In some cases, specific information such as processor model number, generation, and so forth can be included. The total computing system, total computing resources, or both can have a significant impact on how long it will take for a job to execute. For example, consider a highly multi-threaded job. The job may take much longer to execute on a system with only four cores than it takes to execute on a system with eight cores. Similarly, a job with large memory demands may execute much faster on a system with 64 GB of RAM than one with only 16 GB, as the system with only 16 GB of RAM may have to utilize swap space to a greater extent. If swap space is utilized, the execution time can depend significantly on what type of non-volatile storage (e.g., solid state or magnetic disk) is used.

It can also be significant to understand the current and/or expected loads on computing systems. For example, a computing system may have 16 CPU cores, but only a fraction of those cores may be available because other jobs are already running on the computing system, or a computing system may have a 200 Gbps ethernet adapter, but other data transfers may be consuming a significant amount of this capacity. In some implementations, resources may free up and be available when a particular job begins running. Thus, it can be significant to predict execution durations, which can help determine when certain resources or computing systems are expected to be available.

In some implementations, the approaches herein determine total computing resources, available computing resources, and/or resource demands of a job. This information can be used for various purposes, such as predicting how long it will take to execute a job, determining if there are sufficient resources available for executing the job, determining actions to take to enable a job to run successfully or within a time limit, and so forth. For example, if a job has very high memory demands, it can be assigned to a system with more memory than another job that has relatively low memory demands, or a job can be scheduled for a time when more resources are expected to be available. In cases where the results of a job are needed by a certain time, other jobs (e.g., jobs that are less time-sensitive) can be rescheduled for later so that the time-sensitive job can finish executing in time to make the results available when they are needed.

### Execution Duration Prediction and Scheduling Optimization

As described herein, processing batch jobs presents several challenges. For example, users may not know when a job will be completed. In some cases, other jobs may depend on a particular job having finished running, and such other jobs may be delayed while waiting for the particular job to complete. Users may have a general idea of how long a job typically takes to complete, but such estimates fail to account for current loads on computing systems, available resources, the number of other jobs that need to be executed, and so forth. Additionally, such estimates do not account for changes in the volume of data being processed, changes in the complexity of calculations, etc. Scheduling is often poorly managed, with little or no thought being given to the order in which jobs should be run. This can lead to more important or mission-critical jobs being delayed while other, less important jobs are executed.

In some implementations, a machine learning model (or multiple machine learning models) is used to make predictions that can be used to predict estimated completion times, to suggest optimal scheduling windows or times, and so forth. In some implementations, a machine learning model can be trained using historical run data (e.g., job names, affected objects (e.g., databases, tables, files, etc.), execution times, resource usage), information about computing resources, and so forth. The machine learning model can be trained to predict resource usage, execution durations (which can be used to determine completion times), etc. For example, a machine learning model can be trained to ingest information about a job and determine resource needs associated with the job. In some implementations, the machine learning model is trained to ingest information about a job and information about available computing systems or resources in order to predict, for example, how long a job will take to execute. Available computing resources and/or available computing resource components can include currently available computing systems and/or resources, projected available computing systems and/or resources, or both. In some implementations, a machine learning model accepts information about a plurality of jobs and information about available computing resources and optimizes scheduling of the jobs. In some implementations, a system is configured to automatically apply scheduling recommendations output by the machine learning model. Alternatively or additionally, scheduling recommendations can be presented to a user (e.g., on a dashboard), and the user can choose whether to accept or reject some or all of the scheduling recommendations.

In some implementations, estimated execution times, recommended scheduling windows, and/or other information are made available via an API. This can be significant as scheduling is often controlled by third-party applications, or users may want to make such information available in various ways, for example as part of a dashboard, emailed report, etc.

By identifying optimized times, estimated completion times, and so forth, a system and/or users/administrators can better utilize available computing resources. Advantageously, some implementations consider the specific computing resource component demands for particular jobs, enabling more accurate, job-specific predictions and scheduling optimization.

### Self-Healing and Problem Prevention

A wide variety of issues can arise during the execution of a job. Issues can reflect problems with a job, problems with software used for executing the job, hardware failures or limitations, cloud service provider restrictions, and so forth. For example, a network connection may be interrupted, high network utilization may cause slow transfers or timeouts, and so forth. Memory leaks can cause a job to hang or crash as there is not enough free memory to execute the job. High CPU demand can cause a job to hang. A disk may become full and thus be unable to write data. Disk I/O failures can cause read/write operations to fail, and so forth. Network interruptions or network interface card saturation can cause transfers to error out or time out, causing a job to stop or crash. Problems in software such as infinite loops, unhandled exceptions, and so forth can cause a job to hang or crash. Often, code for executing jobs relies on other software libraries or packages, which may be unavailable on a system, outdated, or corrupted, resulting in job failures. Jobs also often rely on data from external sources. An external source may be unavailable, an API call to an external source may fail, and so forth, resulting in the job failing. In some cases, configuration errors may cause a job to hang or fail. For example, a job may utilize incorrect credentials for accessing a database or external service, or required environment variables may not be set or may be set incorrectly. Resource deadlocks, in which two processes wait for resources held by each other, can cause jobs to hang. Security restrictions, such as file access permissions, database access permissions, firewall rules, and so forth can cause jobs to be unable to access required resources. In some cases, hardware may malfunction or otherwise become unavailable, for example due to a power outage. These are merely examples of events that can cause a job to fail or hang. It will be appreciated that this is not an exhaustive listing of possible failure modes.

In some cases, a job may fail due to issues with the job itself; however, a job can also fail because of other jobs or processes. For example, if two jobs are executing on a computing system, one job may fail because the other job is consuming too many resources (e.g., network throughput, memory). Accordingly, when predicting and/or mitigating job failures, hangs, etc., it can be significant to consider not only a job itself, but also other jobs, tasks, processes, and so forth that are executing or scheduled for execution on a computing system.

As described herein, cloud computing services can alleviate many problems that are commonly encountered when running jobs, for example because cloud computing resources are typically highly scalable on demand. However, cloud computing services may require upfront payment, or may have pre-defined limits on usage. For example, a company may set limits so that its cloud computing services bill is not higher than expected or does not exceed a certain limit. In some cases, it can be desirable to automatically manage limits, credits, etc., for a cloud computing service in order to ensure that jobs that are run on the cloud computing service complete successfully. This can be desirable because, for example, a company may prefer spending additional money over not having a job complete. Moreover, if jobs fail partway through, a company can incur expenses associated with running such jobs while also not getting results from those jobs.

In some implementations, the approaches herein can be used to prevent issues from arising. For example, jobs can be scheduled at times when resources are available, credit limits can be automatically managed, jobs can be assigned to specific computing systems, and so forth. The approaches herein can proactively prevent many issues from occurring. A self-healing agent can, additionally or alternatively, also respond to problems that arise during execution, for example to salvage critical jobs, move jobs around to different computing resources, delay jobs, make jobs run earlier, etc.

### EXAMPLE IMPLEMENTATIONS

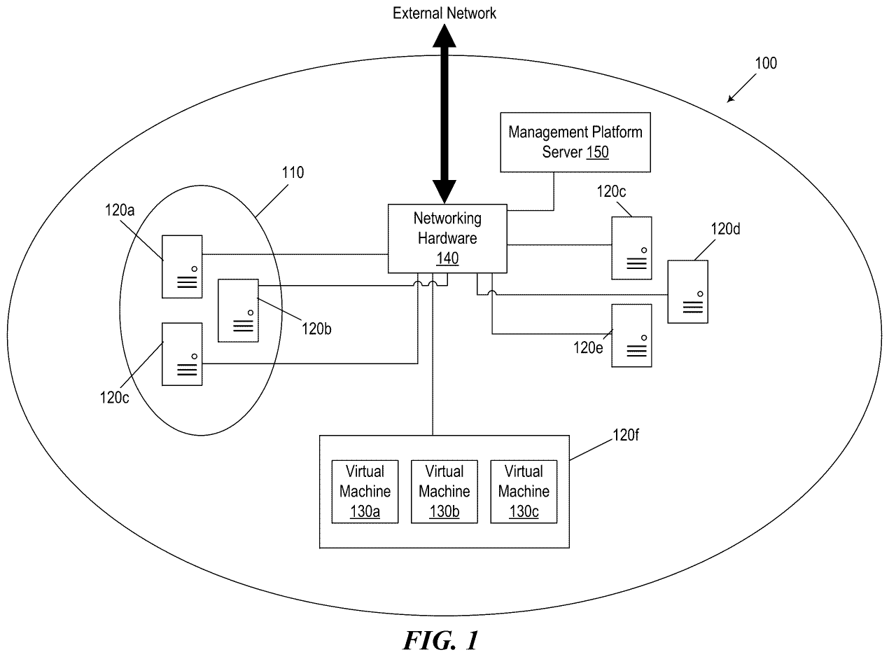

FIG. 1 is a drawing that schematically illustrates an example computing environment 100 that can be used for executing jobs according to some implementations.

The computing environment 100 can include various computing systems, such as a cluster 110. The cluster 110 can include a plurality of servers (e.g., server 120a, server 120b, and server 120c). The computing environment 100 can include standalone servers, such as server 120c, server 120d, and server 120e. The computing environment 100 can include a server 120f that hosts a plurality of virtual machines (e.g., virtual machine 130a, virtual machine 130b, and virtual machine 130c). It will be appreciated that there can be any number of clusters, and the number of individual servers in each cluster can vary, for example including two or more servers. In some implementations, one or more servers in a cluster can host one or more virtual machines. Additionally, there can be any number of standalone servers and any number of servers that host any number of virtual machines. As used in the disclosure, a computing system can refer to an individual computing system such as a standalone server, laptop, or desktop computer, to a virtual machine, to a cluster, a set of virtual machines, to a set of computing systems, to a set of clusters, etc.

The computing environment 100 can include networking hardware 140. The networking hardware 140 can include, for example, switches, routers, modems, or any other suitable networking equipment that enables communication within and/or outside of the computing environment 100. In some implementations, the networking hardware 140 is connected to an external network, such as the internet or another network.

The computing environment 100 can include a management platform server 150. The management platform server 150 can be a server that is dedicated to management operations as described herein. In some implementations, the management platform server 150 is a virtual machine, part of a cluster, or both. In some implementations, the management platform server 150 is configured to perform tasks in addition to management operations. For example, the management platform server 150 can execute jobs, transmit data to external systems, etc. In FIG. 1, the management platform server 150 is depicted as being part of the computing environment 100; however, it will be appreciated that other implementations are possible. For example, the management platform server 150 can be a server outside the computing environment 100 that communicates with computing resources (e.g., servers, clusters, virtual machines, etc.) within the computing environment 100 via an external network.

Each computing resource, (e.g., cluster 110, servers 120a-f, virtual machines 130a-c) can include computing resource components, such as RAM, storage, network interface cards, CPUs, hardware accelerators (e.g., GPUs, NPUs, FPGAs), etc. Different computing resources can have different software installed or available, different operating systems, etc., although in some cases all computing resources can utilize the same operating system, software, etc. Different jobs can be assigned to different computing resources based on the demands of the job, the capabilities of different computing resources, etc.

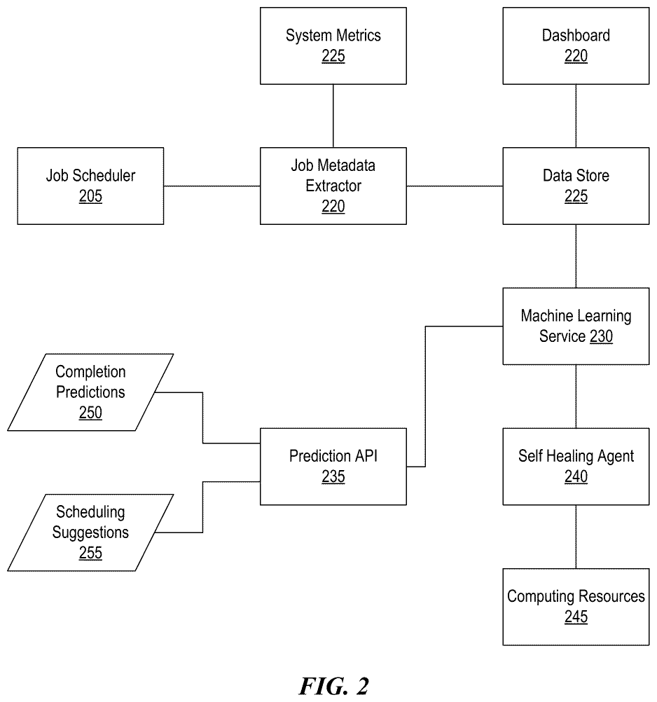

FIG. 2 is a block diagram that illustrates an example smart management platform and associated external components according to some implementations. Jobs can be scheduled using a job scheduler 205. The job scheduler 205 can be any of various job scheduling tools, such as Control-M by BMC, slurm, Azure Data Factory by Microsoft, cron, and so forth. In some cases, multiple job schedulers may be used. The smart management platform can include a job metadata extractor 210. The job metadata extractor 210 can be configured to access and/or analyze information provided by or created by the job scheduler 205. In some implementations, the metadata inspector obtains job information that can be used for determining additional information. For example, the metadata inspector can examine the job information to determine affected tables, scripts that are executed, etc., and can perform subsequent analysis to determine additional information that can be useful for estimating resource usage, execution times, etc. The information can include, for example, a number of rows affected by the job, a number of columns affected by the job, a size of a file used by the job, whether or not the job is marked for execution on a particular computing system (and if so, which computing system(s)), and so forth. In some implementations, the job metadata extractor 210 accesses system metrics 215. System metrics 215 can include information about computing resources (and/or computing resource components) that are available for running jobs. As described herein, computing resources can be physical systems, virtual machines, clusters, etc. The system metrics can include information such as the number of CPU cores, number of GPU or other hardware accelerator cores, type of CPU, type of GPU or other hardware accelerator, amount of RAM, amount of non-volatile storage, type of non-volatile storage, amount of free non-volatile storage, and so forth. The job metadata extractor can store extracted data about scheduled jobs, system metrics, and so forth in a data store 225. The data store 225 can be part of the smart management platform; however, it will be appreciated that the data store 225 does not have to be part of the smart management platform and can instead be an external data store that is accessible by the smart management platform.

The smart management platform can include a machine learning service 230. The machine learning service 230 can provide various functionality, such as powering a prediction API 235 and/or self-healing agent 240. The prediction API 235 can be configured to provide completion predictions 250, which can indicate estimated times when jobs are expected to finish running. In some implementations, the prediction API 235 provides scheduling suggestions 255. As described herein, the smart management platform can use the machine learning service 230 to generate completion predictions 250, scheduling suggestions 255, or both. The prediction API 235 can be used by the smart management platform and can, additionally or alternatively, be used by other applications, reporting pipelines, etc., to determine information related to job completion predictions, scheduling suggestions, and so forth. In some implementations, the scheduling suggestions 255 are used to automatically adjust or set the scheduling of jobs. In some implementations, the scheduling suggestions 255 can be provided to a user (e.g., via a dashboard) but may not be automatically applied. In some implementations, the scheduling suggestions 255 are based at least in part on the completion predictions 250. For example, scheduling suggestions can be based at least in part on how long it is expected that different jobs will take to execute.

As described herein, in some cases, various issues may arise during the execution of a job. For example, a computing system may run out of a resource such as random access memory (RAM), storage, etc. In the case that a cloud platform is used to run a job, there may be insufficient credits to complete the job on the cloud platform. The smart management platform can include a self-healing agent 240. The self-healing agent 240 can automatically correct problems that arise during the execution of a job or take proactive measures to prevent issues. For example, the self-healing agent 240 can be configured to automatically restart computing systems, automatically increase credit limits, and so forth. The self-healing agent 240 can be configured to communicate with computing resources 245. In some implementations, the computing resources are systems that are executing a job. The computing resources 245 can include, additionally or alternatively, one or more systems for managing a cloud platform. For example, the self-healing agent 240 can communicate with a cloud service management platform to automatically manage job scheduling, system restarts, credit limits, and so forth.

Information about job statuses, estimated completion times, suggested prioritizations, suggesting scheduling, and so forth can be populated in a dashboard 220. The dashboard 220 can be part of the smart management platform or can be separate. In some implementations, the dashboard 220 accesses information from the data store 225 for use in populating the dashboard 220. In some implementations, the dashboard is configured to utilize the prediction API 235 to get information related to completion predictions, scheduling suggestions, and so forth.

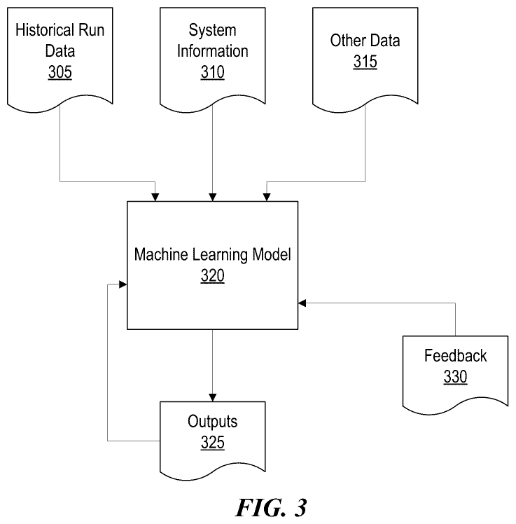

FIG. 3 is a block diagram that illustrates an example of machine learning training and deployment according to some implementations. A machine learning model can accept various input data such as historical run data 305, system information 310, and/or any other information 315. The historical run data 305 can include information such as run times, file sizes, column counts, row counts, etc. The column counts and/or row counts can include total columns and/or rows, affected columns and/or rows, or both. The system information 310 can include information about computing resources and computing resource components, such as number of computing resources, number of CPU cores, number of CPU cores, type of CPU, type of GPU or other hardware accelerator, network connectivity, amount of RAM, amount of free RAM, amount of storage, amount of free storage, and so forth.

The historical run data 305, system information 310, and/or other information 315 can be provided to a machine learning model 320, which can generate an output 325. The output can be, for example, an estimated run time, an estimated output size, a suggested priority, a suggested scheduling time, etc. The output 325 can be provided to the machine learning model 320. The machine learning model 320 can be, for example, a regression model, such as a linear regression model, or any other suitable machine learning model. The machine learning model 320 can receive feedback 330. The feedback 330 can include, for example, the actual run time. The machine learning model can be updated (e.g., in a training process that adjusts one or more weights of the machine learning model) based on the output 325 and the feedback 330. For example, the machine learning model can be trained to minimize the difference between the predicted run time and the actual run time.

In some implementations, the machine learning model is trained to accept job metadata and/or job parameters (which can include job metadata and/or information derived using job metadata) as an input, possibly with other inputs such as system information, and to output an estimated completion time (e.g., how long the job will take to run). In some implementations, the model is a scheduling optimization model that accepts information about a plurality of jobs and determines optimized scheduling for the jobs, for example based on their expected execution times. In some implementations, the model is configured to process information about dependencies between jobs. For example, a first job may need to run before a second job because the second job depends on the outputs of the first job.

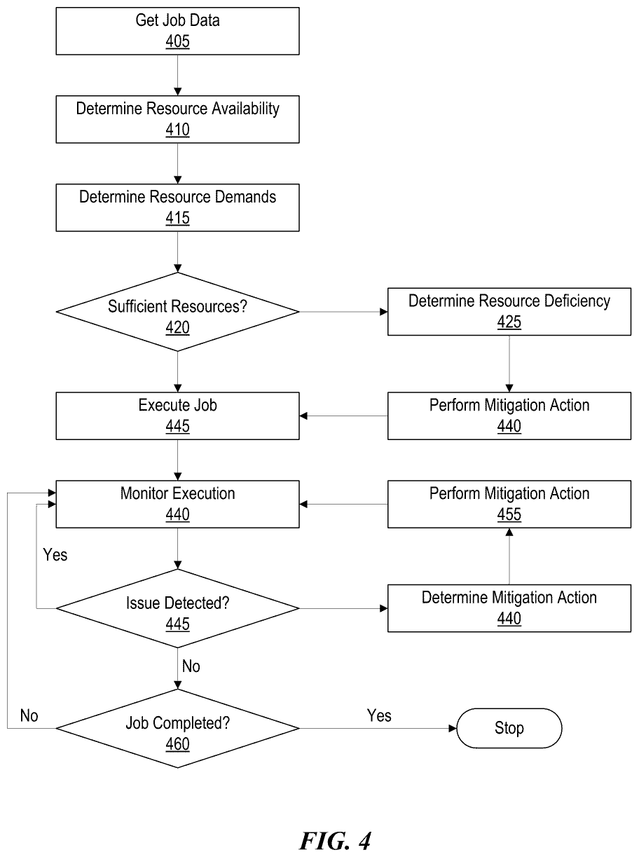

FIG. 4 is a block diagram that illustrates an example job execution and monitoring process according to some implementations. At operation 405, a system can access metadata for a job. The metadata can include, for example, a size of a file to be processed, a number of rows to be processed, a number of columns to be processed, etc. At operation 410, the system can determine resource availability. For example, if the job is to be executed on a computing resource (e.g., a cloud platform, local server, remote server, virtual machine, etc.), the system can determine what the available resources are on the computing resource. For example, the system can determine a memory utilization, free storage space, CPU utilization, hardware accelerator (e.g., GPU, NPU, FPGA) utilization, etc. At operation 415, the system can determine resource demands for the job, for example using a machine learning model or other predictive algorithm as described herein. At operation 420, the system can determine if the computing system has sufficient resources available for executing the job, for example by comparing the resource demands to the resource availability. If there are not sufficient resources available, the system can determine the resource deficiency at operation 425. For example, there may not be enough available memory, enough storage, enough cloud service credits, etc., for executing the job. At operation 430, the system can perform a mitigation action based on the determined resource deficiency. For example, the system can delay execution of the job, allocate more resources to a system (e.g., increase the RAM, storage, number of cores, etc., allocated to a virtual machine), select a different computing system for executing the job, create an additional virtual machine, etc. In the case of a cloud service credit deficiency, the system can communicate with the cloud service to purchase additional credits, increase a spending limit, or the like.

At operation 435, the system can execute the job on the computing resource. At operation 440, the system can monitor execution of the job. Issues can arise during execution that could prevent or delay successful execution of the job. For example, another job may start to consume more resources, leaving fewer resources for the job, or other jobs may consume cloud service credits, resulting in there being an insufficient number of credits to complete execution of the job. At operation 445, the system can determine if there is an example with the job. If so, the system can determine a mitigation action, such as allocating additional resources, pausing the job, pausing other jobs, purchasing additional cloud service credits, etc. At operation 455, the system can perform the mitigation action. The system can continue monitoring execution of the job. If no issues are detected, the system can, at operation 460, determine if the job is complete. If not, the system can continue monitoring execution of the job. If the job is complete, the process can stop.

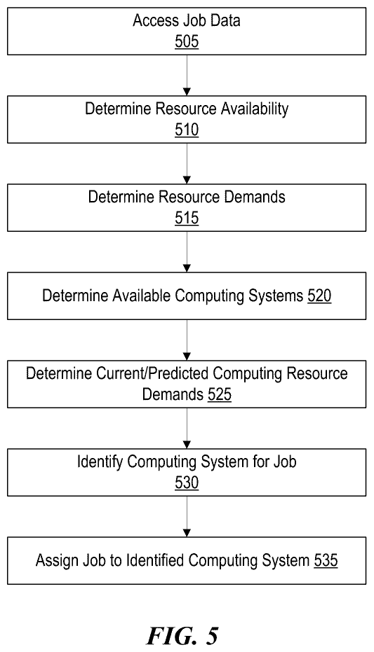

FIG. 5 is a flowchart that illustrates an example resource-aware scheduling process according to some implementations. At operation 505, a system can access job metadata for a job. The job metadata can include, for example, job name, job requirements (e.g., required computing resource components), job dependencies (e.g., databases, tables, files, other jobs), file size, row count, column count, or any other information. At operation 510, the system can determine which computing resources of a computing environment (e.g., computing environment 100 in FIG. 1) are available. At operation 515, the system can determine the resource demand (e.g., which computing resource) are needed for running the job. At operation 520, the system can determine which of the available computing systems meet the resource demand of the job. For example, a job may require one terabyte of free storage, but only some of the available computing systems may have at least one terabyte of storage free. As another example, a job may require that a certain application or application version be installed, and only a subset of computing systems may have the application (or the correct version of the application) installed. Computing systems that do not meet the demands for specific computing resources can be eliminated from consideration for running the job. At operation 525, the system can determine current and/or predicted computing system demands. For example, a computing system may meet the requirements for running the job, but may already be running other jobs or there may be other jobs scheduled to run on the computing system. Such computing systems can be eliminated from consideration or scheduling can be configured to allow the job to run on such computing systems. At operation 530, the system can identify a computing system for executing the job. For example, the system can identify a computing system that is currently idle or expected to be idle when the job runs. In some cases, the system can select a computing system that is busy or expected to be busy and can modify scheduling such that the job can be run on such a computing system, for example by moving another job to another computing system. At operation 535, the system can assign the job to execute on the identified computing system.

In some cases, jobs may be configured to run on specific computing system (e.g., a user who creates the job can configure the job to only run on a particular computing system or particular computing system). In such cases, the resource-aware scheduling process may not be used to assign such jobs. However, information about such jobs can still be utilized. For example, the resource-aware scheduling process can use such information in determining assigned computing systems for other jobs. For example, such information can be used for determining which computing systems are expected to be busy running other jobs at a future time.

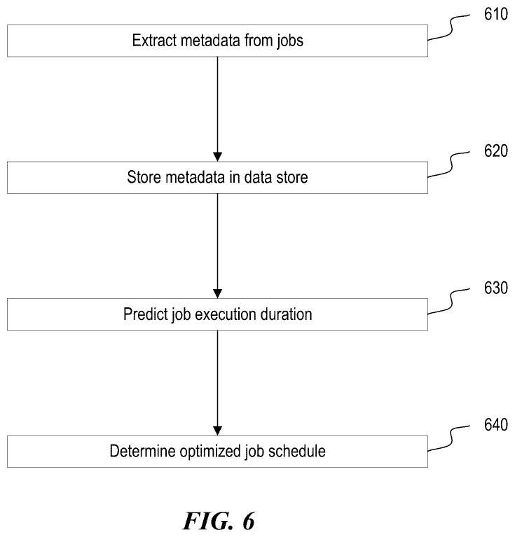

FIG. 6 is a flowchart that illustrates an example job execution duration prediction and scheduling optimization process according to some implementations. At operation 610, a system can extract metadata for a plurality of scheduled jobs. At operation 620, the system can store the metadata in a data store, for example as described herein. At operation 630, the system can predict execution times for each job of the plurality of jobs. For example, using the approaches described herein, the system can determine resources needed for running each job, computing systems (e.g., servers, virtual machines, clusters) for running each job, and so forth. The system can predict how long each job will take to execute, for example using a machine learning model as described herein. At operation 640, the system can determine an optimized job schedule. In some implementations, the optimized job schedule can be made up of a plurality of schedules. For example, there can be different schedules associated with different computing systems, which can be useful when multiple jobs are assigned to a specific computing system or set of computing systems. The optimized job schedule can account for dependencies between jobs, job priorities (if specified), required or desired data availability times (e.g., data may be needed by a particular time), etc. The optimized job schedule can order jobs such that computing systems are used efficiently. For example, idle time can be reduced. In some implementations, the optimized job schedule can account for competing demands. For example, if two jobs need to pull information from the same file server, it may be advantageous to schedule those jobs to run at different times so that they do not compete for the file server's resources (e.g., hard drive transfer speed, network interface capacity).

### Computer System

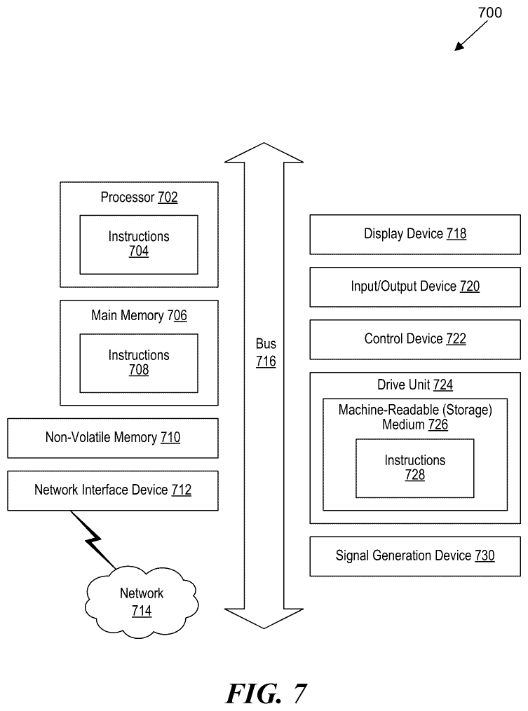

FIG. 7 is a block diagram that illustrates an example of a computer system 700 in which at least some operations described herein can be implemented. As shown, the computer system 700 can include: one or more processors 702, main memory 706, non-volatile memory 710, a network interface device 712, a video display device 718, an input/output device 720, a control device 722 (e.g., keyboard and pointing device), a drive unit 724 that includes a machine-readable (storage) medium 726, and a signal generation device 730 that are communicatively connected to a bus 716. The bus 716 represents one or more physical buses and/or point-to-point connections that are connected by appropriate bridges, adapters, or controllers. Various common components (e.g., cache memory) are omitted from FIG. 7 for brevity. Instead, the computer system 700 is intended to illustrate a hardware device on which components illustrated or described relative to the examples of the figures and any other components described in this specification can be implemented.

The computer system 700 can take any suitable physical form. For example, the computing system 700 can share a similar architecture as that of a server computer, personal computer (PC), tablet computer, mobile telephone, game console, music player, wearable electronic device, network-connected (“smart”) device (e.g., a television or home assistant device), AR/VR systems (e.g., head-mounted display), or any electronic device capable of executing a set of instructions that specify action(s) to be taken by the computing system 700. In some implementations, the computer system 700 can be an embedded computer system, a system-on-chip (SOC), a single-board computer system (SBC), or a distributed system such as a mesh of computer systems, or it can include one or more cloud components in one or more networks. Where appropriate, one or more computer systems 700 can perform operations in real time, in near real time, or in batch mode.

The network interface device 712 enables the computing system 700 to mediate data in a network 714 with an entity that is external to the computing system 700 through any communication protocol supported by the computing system 700 and the external entity. Examples of the network interface device 712 include a network adapter card, a wireless network interface card, a router, an access point, a wireless router, a switch, a multilayer switch, a protocol converter, a gateway, a bridge, a bridge router, a hub, a digital media receiver, and/or a repeater, as well as all wireless elements noted herein.

The memory (e.g., main memory 706, non-volatile memory 710, machine-readable medium 726) can be local, remote, or distributed. Although shown as a single medium, the machine-readable medium 726 can include multiple media (e.g., a centralized/distributed database and/or associated caches and servers) that store one or more sets of instructions 728. The machine-readable medium 726 can include any medium that is capable of storing, encoding, or carrying a set of instructions for execution by the computing system 700. The machine-readable medium 726 can be non-transitory or comprise a non-transitory device. In this context, a non-transitory storage medium can include a device that is tangible, meaning that the device has a concrete physical form, although the device can change its physical state. Thus, for example, non-transitory refers to a device remaining tangible despite this change in state.

Although implementations have been described in the context of fully functioning computing devices, the various examples are capable of being distributed as a program product in a variety of forms. Examples of machine-readable storage media, machine-readable media, or computer-readable media include recordable-type media such as volatile and non-volatile memory 710, removable flash memory, hard disk drives, optical disks, and transmission-type media such as digital and analog communication links.

In general, the routines executed to implement examples herein can be implemented as part of an operating system or a specific application, component, program, object, module, or sequence of instructions (collectively referred to as “computer programs”). The computer programs typically comprise one or more instructions (e.g., instructions 704, 708, 728) set at various times in various memory and storage devices in computing device(s). When read and executed by the processor 702, the instruction(s) cause the computing system 700 to perform operations to execute elements involving the various aspects of the disclosure.

### Remarks

The terms “example,” “embodiment,” and “implementation” are used interchangeably. For example, references to “one example” or “an example” in the disclosure can be, but not necessarily are, references to the same implementation; and such references mean at least one of the implementations. The appearances of the phrase “in one example” are not necessarily all referring to the same example, nor are separate or alternative examples mutually exclusive of other examples. A feature, structure, or characteristic described in connection with an example can be included in another example of the disclosure. Moreover, various features are described that can be exhibited by some examples and not by others. Similarly, various requirements are described that can be requirements for some examples but not for other examples.

The terminology used herein should be interpreted in its broadest reasonable manner, even though it is being used in conjunction with certain specific examples of the invention. The terms used in the disclosure generally have their ordinary meanings in the relevant technical art, within the context of the disclosure, and in the specific context where each term is used. A recital of alternative language or synonyms does not exclude the use of other synonyms. Special significance should not be placed upon whether or not a term is elaborated or discussed herein. The use of highlighting has no influence on the scope and meaning of a term. Further, it will be appreciated that the same thing can be said in more than one way.

Unless the context clearly requires otherwise, throughout the description and the claims, the words “comprise,” “comprising,” and the like are to be construed in an inclusive sense, as opposed to an exclusive or exhaustive sense—that is to say, in the sense of “including, but not limited to.” As used herein, the terms “connected,” “coupled,” and any variants thereof mean any connection or coupling, either direct or indirect, between two or more elements; the coupling or connection between the elements can be physical, logical, or a combination thereof. Additionally, the words “herein,” “above,” “below,” and words of similar import can refer to this application as a whole and not to any particular portions of this application. Where context permits, words in the above Detailed Description using the singular or plural number may also include the plural or singular number, respectively. The word “or” in reference to a list of two or more items covers all of the following interpretations of the word: any of the items in the list, all of the items in the list, and any combination of the items in the list. The term “module” refers broadly to software components, firmware components, and/or hardware components.

While specific examples of technology are described above for illustrative purposes, various equivalent modifications are possible within the scope of the invention, as those skilled in the relevant art will recognize. For example, while processes or blocks are presented in a given order, alternative implementations can perform routines having steps, or employ systems having blocks, in a different order, and some processes or blocks may be deleted, moved, added, subdivided, combined, and/or modified to provide alternative or sub-combinations. Each of these processes or blocks can be implemented in a variety of different ways. Also, while processes or blocks are at times shown as being performed in series, these processes or blocks can instead be performed or implemented in parallel or can be performed at different times. Further, any specific numbers noted herein are only examples such that alternative implementations can employ differing values or ranges.

Details of the disclosed implementations can vary considerably in specific implementations while still being encompassed by the disclosed teachings. As noted above, particular terminology used when describing features or aspects of the invention should not be taken to imply that the terminology is being redefined herein to be restricted to any specific characteristics, features, or aspects of the invention with which that terminology is associated. In general, the terms used in the following claims should not be construed to limit the invention to the specific examples disclosed herein, unless the above Detailed Description explicitly defines such terms. Accordingly, the actual scope of the invention encompasses not only the disclosed examples but also all equivalent ways of practicing or implementing the invention under the claims. Some alternative implementations can include additional elements to those implementations described above or include fewer elements.

Any patents and applications and other references noted above, and any that may be listed in accompanying filing papers, are incorporated herein by reference in their entireties, except for any subject matter disclaimers or disavowals, and except to the extent that the incorporated material is inconsistent with the express disclosure herein, in which case the language in this disclosure controls. Aspects of the invention can be modified to employ the systems, functions, and concepts of the various references described above to provide yet further implementations of the invention.

To reduce the number of claims, certain implementations are presented below in certain claim forms, but the applicant contemplates various aspects of an invention in other forms. For example, aspects of a claim can be recited in a means-plus-function form or in other forms, such as being embodied in a computer-readable medium. A claim intended to be interpreted as a means-plus-function claim will use the words “means for.” However, the use of the term “for” in any other context is not intended to invoke a similar interpretation. The applicant reserves the right to pursue such additional claim forms either in this application or in a continuing application.

What is claimed is:

1. A computer-implemented method for executable job management, the computer-implemented method comprising:
accessing job metadata for an executable job, wherein the executable job is configured to be executed in a computing environment;
determining, using the job metadata, a set of job parameters for the executable job,
wherein the set of job parameters comprises at least one job parameter, and
wherein the at least one job parameter comprises at least one of: a scheduled execution time, a file size, a file name, a file path, a row count, a column count, a database name, a table name, a designated computing system for executing the executable job, a minimum RAM amount, a minimum storage amount, a minimum network capacity, a central processing unit (CPU) requirement, a hardware accelerator requirement, a software dependency, or a job identifier;
accessing at least one resource level associated with the computing environment,
wherein the at least one resource level comprises at least one of: CPU count, CPU core count, hardware accelerator count, hardware accelerator core count, hardware accelerator type, memory capacity, network capacity, storage capacity, software availability, free memory capacity, free network capacity, free storage capacity, current network load, current CPU load, current hardware accelerator load, projected network load, projected CPU load, or projected hardware accelerator load;
generating an input for a machine learning model using at least a portion of the set of job parameters;
providing the input to the machine learning model to cause the machine learning model to determine a demand level of a resource associated with the executable job;
determining an available level of the resource in the computing environment;
comparing the available level of the resource to the demand level of the resource;
when the available level is less than the demand level:
determining an action to perform on the computing environment, wherein the action causes the available level to be greater than or equal to the demand level;
monitoring execution of the executable job in the computing environment;
determining a current demand level of the resource, wherein the current demand level is determined using the demand level of the resource;
determining a current available level of the resource;
comparing the current available level of the resource to the current demand level of the resource; and
when the current available level of the resource is less than the current demand level of the resource:
determining a second action to perform on the computing environment, wherein the second action causes the current available level of the resource to be greater than or equal to the current demand level of the resource.

2. A system comprising:
at least one hardware processor; and
a non-transitory medium storing instructions which, when executed by the at least
one hardware processor, cause the system to:
access job metadata for an executable job to be executed in a computing environment;
determine, using the job metadata, one or more job parameters associated with the executable job;
determine an available resource level associated with the computing environment;
generate an input using at least one job parameter of the one or more job parameters and the available resource level;
provide the input to a machine learning model configured to predict an estimated execution time of the executable job;
determine, using the machine learning model, the estimated execution time of the executable job; and
generate an output for display to a user, the output indicating the estimated execution time of the executable job,
wherein the machine learning model is trained to determine the estimated execution time using at least two of: historical resource usage data, historical job execution time data, historical job parameter data, or historical computing environment performance data.

3. The system of claim 2, wherein the instructions are further configured to cause the system to:
determine a demand level of the executable job for a resource;
determine an available level of the resource in the computing environment;
determine a difference between the demand level of the resource and the available level of the resource; and
when the demand level is greater than the available level:
determine an action to perform on the computing environment, wherein the action causes the available level to be equal to or greater than the demand level.

4. The system of claim 2, wherein the one or more job parameters comprise an affected row count,
wherein the instructions are further configured to determine the affected row count by:
determining, from the job metadata, a table in a database that is involved in execution of the executable job; and
executing a query against the table in the database, wherein the query is configured to determine a number of rows in the table.

5. The system of claim 2, wherein the one or more job parameters comprises a file size,
where the instructions are further configured to determine the file size by:
determining, using the job metadata, a path of a file that is involved in execution of the executable job; and
determining a size of the file.

6. The system of claim 2, wherein the instructions are further configured to cause the system to:
monitor execution of the executable job;
determine an abnormal state of the executable job; and
determine an action, wherein the action causes resolution of the abnormal state.

7. The system of claim 6, wherein the action comprises at least one of: restarting a virtual machine of the
computing environment, restarting a cluster of the computing environment, restarting the executable job, or increasing an available level of a resource.

8. The system of claim 2, wherein the instructions are further configured to cause the system to:
determine an estimated optimal scheduling time window for the executable job; and
update a scheduling information of the executable job to cause the executable job to begin execution within the estimated optimal scheduling time window.

9. The system of claim 3, wherein the demand level for the resource comprises a demand for at least one of: central processing unit capacity, graphical processing unit capacity, neural processing unit capacity, volatile memory capacity, non-volatile storage capacity, or network interface capacity.

10. The system of claim 3, wherein the computing environment comprises a cloud computing environment,
wherein the demand level of the resource comprises a demand for cloud computing capacity,
wherein the action comprises a procurement of additional cloud computing capacity, and
wherein the instructions further cause the system to:
execute a transaction that causes procurement of the additional cloud computing capacity.

11. The system of claim 2, wherein the one or more job parameters comprise an affected row count, wherein the instructions are further configured to cause the system to:
determining, using the job metadata, a table in a database that is involved in execution of the executable job; and
executing a database query to determine a number of affected rows in the table.

12. The system of claim 2, wherein the one or more job parameters comprise a file size, wherein the instructions are further configured to cause the system to:
determining, using the job metadata, a path of a file that is involved in execution of the executable job; and
determining a size of the file using a file operation.

13. A computer-implemented method for job management, the computer-implemented method comprising:
accessing job metadata for an executable job to be executed in a computing environment;
determining, using the job metadata, one or more job parameters associated with the executable job;
determining an available resource level associated with the computing environment;
generating an input for a machine learning model using at least one job parameter of the one or more job parameters and the available resource level;
providing the input to the machine learning model, wherein the machine learning model is configured to predict an estimated execution time of the executable job;
determining, using the machine learning model, the estimated execution time of the executable job; and
generating an output for display to a user, the output indicating the estimated execution time of the executable job,
wherein the machine learning model is trained to determine the estimated execution time using at least two of: historical resource usage data, historical job execution time data, historical job parameter data, or historical computing environment performance data.

14. The computer-implemented method of claim 13, further comprising:
determining a demand level of the executable job for a resource;
determining an available level of the resource in the computing environment;
determining a difference between the demand level of the resource and the available level of the resource; and
when the demand level of the resource is greater than the available level of the resource:
determining an action, wherein the action causes the available level of the resource to be equal to or greater than the demand level of the resource.

15. The computer-implemented method of claim 13, further comprising:
monitoring execution of the executable job;
determining an abnormal state of the executable job; and
determining an action, wherein the action causes resolution of the abnormal state.

16. The computer-implemented method of claim 15, wherein the action comprises at least one of: restarting a virtual machine of the
computing environment, restarting a cluster of the computing environment, restarting the executable job, or increasing an available level of a resource.

17. The computer-implemented method of claim 13, further comprising:
determining an estimated optimal scheduling time window for the executable job; and
updating a scheduling information of the executable job to cause the executable job to begin execution within the estimated optimal scheduling time window.

18. The computer-implemented method of claim 14, wherein the demand level of the resource comprises a demand for at least one of: central processing unit capacity, graphical processing unit capacity, neural processing unit capacity, volatile memory capacity, non-volatile storage capacity, or network interface capacity.

19. The computer-implemented method of claim 14, wherein the computing environment comprises a cloud computing environment,
wherein the demand level of the resource comprises a demand for cloud computing capacity,
wherein the action comprises a procurement of additional cloud computing capacity, and
wherein the computer-implemented method further comprises executing a transaction that causes procurement of the additional cloud computing capacity.

20. The computer-implemented method of claim 13, wherein the one or more job parameters comprise an affected row count, the computer-implemented method further comprising:
determining, from the job metadata, a table in a database that is involved in execution of the executable job; and
executing a database query to determine a number of affected rows in the table.
